(19) United States
(12) Patent Application Publication
(10) Pub. No.: US 2013/0097792 A1
(43) Pub. Date: Apr. 25, 2013

(54) Plastic Lined Wipe For Sanitary Cleanup of Diaper Area or Personal Cleansing

(71) Applicant: Mikel George DeFrancesco, Quincy, MA (US)

(72) Inventor: Mikel George DeFrancesco, Quincy, MA (US)

(21) Appl. No.: 13/657,509

(22) Filed: Oct. 22, 2012

Related U.S. Application Data
(60) Provisional application No. 61/550,197, filed on Oct. 21, 2011.

(51) Int. Cl. A47L 13/17; B08B 1/00; A47K 7/04

(52) U.S. Cl. 15/104.94

(57) ABSTRACT

This invention relates to a disposable wipe with top and bottom layers for cleaning and an intermediate layer that prevents any liquids or solids from transmitting between the top and bottom layers.

### CROSS REFERENCE TO RELATED APPLICATION

This application claims the benefit of U.S. Provisional Patent Application No. 61/550,197 filed on Oct. 21, 2011, the contents of which are incorporated herein by reference.

### FIELD OF THE INVENTION

This invention relates to a disposable wipe with top and bottom layers for cleaning and an intermediate layer that prevents any liquids or solids from transmitting between the top and bottom layers.

### BACKGROUND OF INVENTION

Handheld disposable wipes are a common approach for quickly cleaning messes on a baby's skin. Handheld disposable wipes have also become popular for quickly cleaning small portions of glass, countertops, appliances, and other kitchen or bathroom surfaces. These disposable wipes are usually infused with a cleaning solution to aid in the cleaning. These disposable wipes are also absorbent to pick up excess cleaning solution, liquid messes, and solid messes from the cleaned skin or surfaces.

Since these disposable wipes are handheld, they often transmit bacteria, germs, viruses, or small portions of the messes being cleaned onto the user's hand. Even if the disposable wipes are infused with sanitizing or anti-bacterial liquids, it is often recommended to wash the user's hand after using the wipe to prevent the spread of contamination. If a user does not wash his or her hands, the contaminants may be spread onto other parts of the user's body, other clean surfaces, or other people. Young children, pregnant women, elderly, and immune-comprised people will be particularly susceptible to this spread of contamination.

To reduce the transmission of these contaminants, users often fold the wipes into multiple layers. This folding results in inefficient use of the cleaning surface of the wipes. This folding may reduce the amount of contaminants reaching the user's hands, but it doesn't eliminate them.

The subject invention discloses a solution to this problem. The subject invention is a handheld disposable wipe for human skin; or glass, countertops, appliances, and other kitchen or bathroom surfaces. The wipes contain two separate cleaning absorbent layers separated by a layer of plastic lining. The plastic lining layer prevents any transmission from the cleaned surfaces to the user's hands. The two separate absorbent surfaces double the absorbing and cleaning power of the wipe. Furthermore, the symmetrical shape allows doubling of the usable area and for folding and re-use of the same wipe. The three layers of the wipe resist tearing.

This invention completely solves that problem of contaminants being transmitted onto a user's hand. This wipe is a more sanitary product that reduces the spread of illness. This wipe is also more efficient since it reduces the overall number of wipes used when cleaning since only one wipe at a time is necessary when cleaning.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a handheld, disposable skin wipe comprising: a substantially planar first absorbent layer with a top surface and a bottom surface, wherein the first absorbent layer is infused with a first solution; a substantially planar second absorbent layer with a top surface and a bottom surface, wherein the second absorbent layer is infused with a second solution; a substantially planar fluid impervious layer with a top surface and a bottom surface, wherein the top surface of the fluid impervious layer is attached to the bottom surface of the first absorbent layer, further wherein the bottom surface of the fluid impervious layer is attached to the top surface of the second absorbent layer; wherein the fluid impervious layer prevents fluid from being transferred between the first absorbent layer to the second absorbent layer.

In further embodiments of the subject invention, the first solution and the second solution are selected from the group comprising: a skin non-irritating composition, a hypoallergenic composition, an anti-bacterial composition, an anti-viral composition, an anti-fungal composition, a fragrance, a fragrance-free composition, an aqueous alcoholic composition, an aqueous alcohol-free composition, or any combination thereof.

In embodiments of the subject invention, the first absorbent layer, the second absorbent layer, and the fluid impervious layer are each substantially identical in length, width, and shape. In embodiments of the subject invention, the three layers may be 1″ to 16″ in width, and 1″ to 16″ in length. In further embodiments of the subject invention, the three layers may have the substantially same symmetrical shape that is rectangular, square, circular, hexagonal, or octagonal.

Another embodiment of the subject invention is a handheld, disposable, flexible, cleaning wipe comprising: a substantially flat first liquid-retaining layer with a top cleaning surface and a bottom surface, wherein the first liquid-retaining layer is pre-moistened with an anti-bacterial, anti-viral, and anti-fungal solution; a substantially flat second liquid-retaining layer with a top surface and a bottom cleaning surface, wherein the second liquid-retaining layer is pre-moistened with the anti-bacterial, anti-viral solution, and anti-fungal solution; a substantially flat water-impervious layer with a top surface and a bottom surface, wherein the top surface of the water-impervious layer is attached to the bottom surface of the first liquid-retaining layer, further wherein the bottom surface of the water-impervious layer is attached to the top surface of the second liquid-retaining layer; wherein the water-impervious layer prevents any fluid from being transmitted between the first liquid-retaining layer and the second liquid-retaining layer.

In embodiments of the subject invention, the first liquid-retaining layer, the second liquid-retaining layer, and the water-impervious layer are each substantially identical in length, width, and shape. In embodiments of the subject invention, the three layers may be 1″ to 16″ in width, and 1″ to 16″ in length. In further embodiments of the subject invention, the three layers may have the substantially same symmetrical shape that is rectangular, square, circular, hexagonal, or octagonal.

In an embodiment of the subject invention, the top cleaning surface of the first layer and the bottom cleaning surface of the bottom layer are both configured to clean surfaces selected from the group comprising: skin, glass, countertops, stovetops, appliances, and any combination thereof.

A further embodiment of the subject invention is a handheld, disposable, foldable, cleaning wipe comprising: a substantially flat first absorbent layer with a top cleaning surface and a bottom surface, wherein the first absorbent layer is pre-moistened with an anti-bacterial, anti-viral, and anti-fungal solution; a substantially flat second absorbent layer with a top surface and a bottom cleaning surface, wherein the second absorbent layer is pre-moistened with the anti-bacterial, anti-viral solution, and anti-fungal solution; a substantially flat intermediate plastic film layer with a top surface and a bottom surface, wherein the top surface of the plastic film layer is attached to the bottom surface of the first absorbent layer, further wherein the bottom surface of the plastic film layer is attached to the top surface of the second absorbent layer; wherein the plastic film layer seals the first absorbent layer from the second absorbent layer and prevents any fluid from being transmitted between the layers.

In embodiments of the subject invention, the first absorbent layer, the second absorbent layer, and the plastic layer are each substantially identical in length, width, and shape. In embodiments of the subject invention, the three layers may be 1″ to 16″ in width, and 1″ to 16″ in length. In further embodiments of the subject invention, the three layers may have the substantially same symmetrical shape that is rectangular, square, circular, hexagonal, or octagonal.

In an embodiment of the subject invention, the top cleaning surface of the first layer and the bottom cleaning surface of the bottom layer are both configured to clean surfaces selected from the group comprising: skin, glass, countertops, stovetops, appliances, and any combination thereof.

Another embodiment of the subject invention is a handheld, flushable, flexible, skin-cleaning wipe comprising: a substantially flat first liquid-retaining layer with a top cleaning surface and a bottom surface, wherein the first liquid-retaining layer is pre-moistened with an anti-bacterial, anti-viral, and anti-fungal solution; a substantially flat second liquid-retaining layer with a top surface and a bottom cleaning surface, wherein the second liquid-retaining layer is pre-moistened with the anti-bacterial, anti-viral solution, and anti-fungal solution; a substantially flat water-impervious layer with a top surface and a bottom surface, wherein the top surface of the water-impervious layer is attached to the bottom surface of the first liquid-retaining layer, further wherein the bottom surface of the water-impervious layer is attached to the top surface of the second liquid-retaining layer; wherein the water-impervious layer prevents any fluid from being transmitted between the first liquid-retaining layer and the second liquid-retaining layer.

A further embodiment of the subject invention is a handheld, flushable, foldable, skin-cleaning wipe comprising: a substantially flat first absorbent layer with a top cleaning surface and a bottom surface, wherein the first absorbent layer is pre-moistened with an anti-bacterial, anti-viral, and anti-fungal solution; a substantially flat second absorbent layer with a top surface and a bottom cleaning surface, wherein the second absorbent layer is pre-moistened with the anti-bacterial, anti-viral solution, and anti-fungal solution; a substantially flat intermediate plastic film layer with a top surface and a bottom surface, wherein the top surface of the plastic film layer is attached to the bottom surface of the first absorbent layer, further wherein the bottom surface of the plastic film layer is attached to the top surface of the second absorbent layer; wherein the plastic film layer seals the first absorbent layer from the second absorbent layer and prevents any fluid from being transmitted between the layers.

In embodiments of the subject invention, the first absorbent layer, the second absorbent layer, and the plastic film layer are each substantially identical in length, width, and shape. In embodiments of the subject invention, the three layers may be 1″ to 16″ in width, and 1″ to 16″ in length. In further embodiments of the subject invention, the three layers may have the substantially same symmetrical shape that is rectangular, square, circular, hexagonal, or octagonal.

The subject invention discloses a handheld, flushable, foldable, skin-cleaning wipe comprising: a substantially planar first absorbent layer with a top surface and a bottom surface, wherein the first absorbent layer is infused with a first solution; a substantially planar second absorbent layer with a top surface and a bottom surface, wherein the second absorbent layer is infused with a second solution; a substantially planar bacteria and viral impervious layer with a top surface and a bottom surface, wherein the top surface of the bacteria and viral impervious layer is attached to the bottom surface of the first absorbent layer, further wherein the bottom surface of the bacteria and viral impervious layer is attached to the top surface of the second absorbent layer; wherein the bacteria and viral impervious layer prevents any bacteria or viruses from being transferred between the first absorbent layer to the second absorbent layer.

Another embodiment of the subject invention is a handheld, flushable, flexible, foldable, cleaning wipe comprising: a substantially flat first liquid-retaining layer with a top cleaning surface and a bottom surface, wherein the first liquid-retaining layer is pre-moistened with an anti-bacterial, anti-viral, and anti-fungal solution; a substantially flat second liquid-retaining layer with a top surface and a bottom cleaning surface, wherein the second liquid-retaining layer is pre-moistened with the anti-bacterial, anti-viral solution, and anti-fungal solution; a substantially flat bacteria and viral impervious layer with a top surface and a bottom surface, wherein the top surface of the bacteria and viral layer is attached to the bottom surface of the first liquid-retaining layer, further wherein the bottom surface of the bacteria and viral layer is attached to the top surface of the second liquid-retaining layer; wherein the bacteria and viral layer prevents any bacteria or viruses from being transmitted between the first liquid-retaining layer and the second liquid-retaining layer.

In an embodiment of the subject invention, the top cleaning surface of the first layer and the bottom cleaning surface of the bottom layer are both configured to clean surfaces selected from the group comprising: skin, glass, countertops, stovetops, appliances, and any combination thereof.

A further embodiment of the subject invention is a handheld, flushable, foldable, cleaning wipe comprising: a substantially flat first absorbent layer with a top cleaning surface and a bottom surface, wherein the first absorbent layer is pre-moistened with an anti-bacterial, anti-viral, and anti-fungal solution; a substantially flat second absorbent layer with a top surface and a bottom cleaning surface, wherein the second absorbent layer is pre-moistened with the anti-bacterial, anti-viral solution, and anti-fungal solution; a substantially flat intermediate plastic film layer with a top surface and a bottom surface, wherein the top surface of the plastic film layer is attached to the bottom surface of the first absorbent layer, further wherein the bottom surface of the plastic film layer is attached to the top surface of the second absorbent layer; wherein the plastic film layer seals the first absorbent layer from the second absorbent layer and prevents any bacteria or viruses from being transmitted between the layers.

In an embodiment of the subject invention, the top cleaning surface of the first layer and the bottom cleaning surface of the bottom layer are both configured to clean surfaces selected from the group comprising: skin, glass, countertops, stovetops, appliances, and any combination thereof.

In another embodiment of the subject invention, the wipe is substantially biodegradable within 6 months of placement in a landfill.

In embodiments of the subject invention, the wipe may have a thickness less than one-half inch.

There have thus been broadly outlined important features of the invention in order that the detailed description thereof that follows may be better understood, and in order that the present contribution to the art may be better appreciated. There are additional features of the invention that will be described hereinafter and which will form the subject matter of the claims appended hereto. These together with other embodiments of the invention, and with various features of novelty which characterize the invention, are pointed out with particularity in the claims annexed to and formed as part of this disclosure.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a perspective view of one embodiment of the plastic lined wipe.

FIG. 2 illustrates an enlarged perspective view of one corner A of FIG. 1 of the plastic lined wipe.

FIG. 3 illustrates a top view of the embodiment of the plastic lined wipe.

FIG. 4 illustrates a side view of the embodiment of the plastic lined wipe.

FIG. 5 illustrates an enlarged side view of one corner B of FIG. 4 of the plastic lined wipe.

FIG. 6 illustrates a perspective view of the embodiment of the plastic lined wipe.

FIG. 7 illustrates an enlarged perspective view of one corner C of FIG. 6 of the plastic lined wipe.

### DETAILED DESCRIPTION OF THE PREFERRED EMBODIMENTS

The following will describe, in detail, several embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

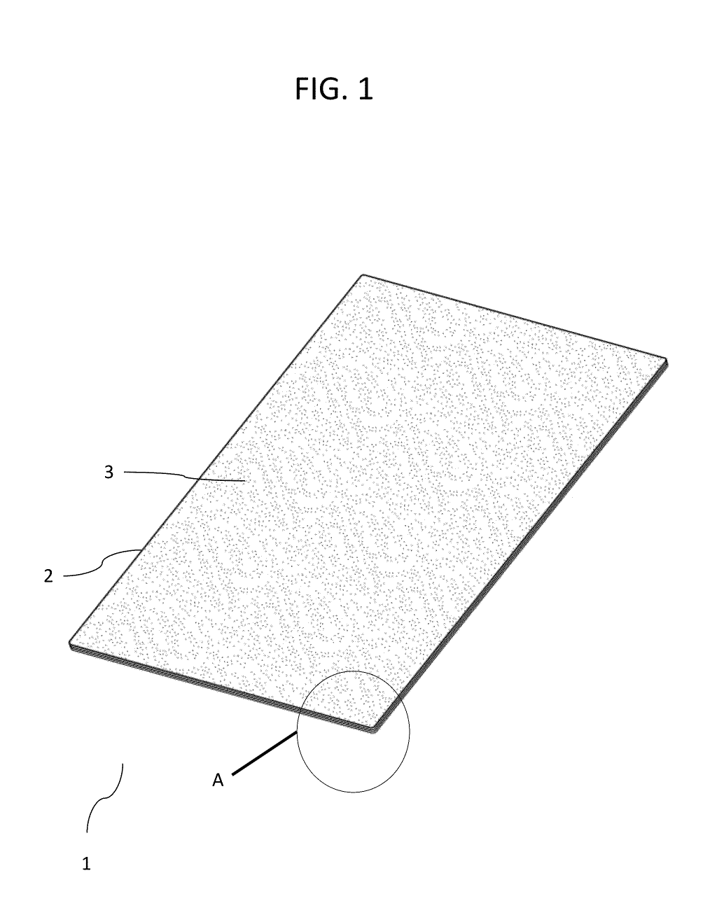

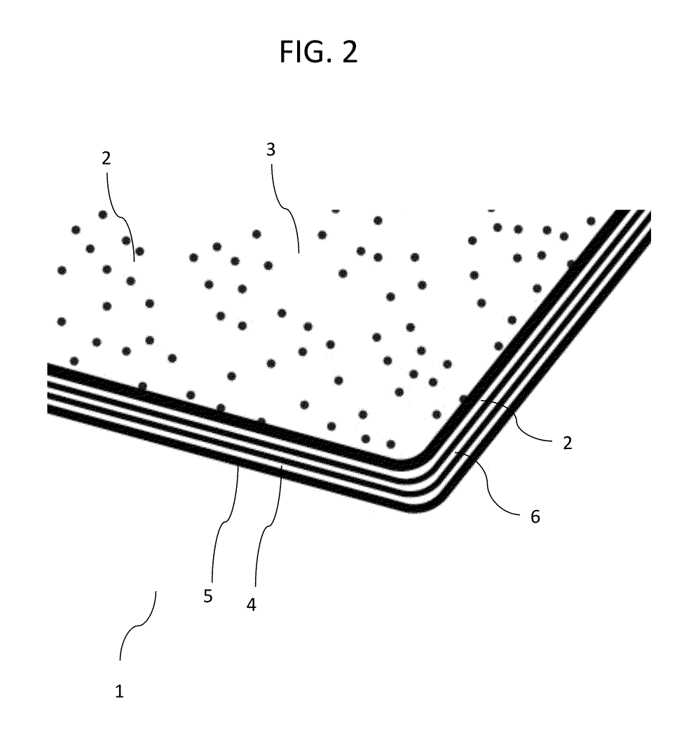

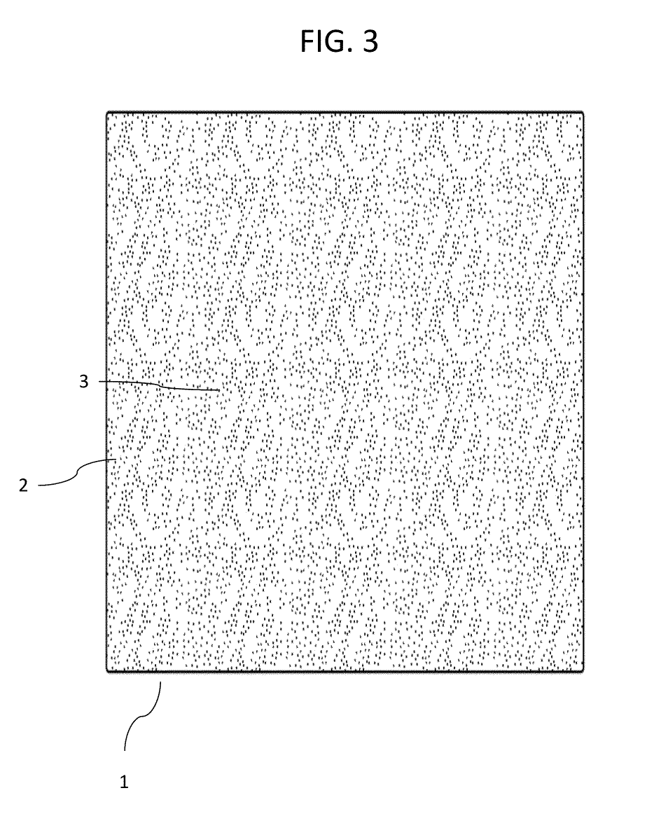

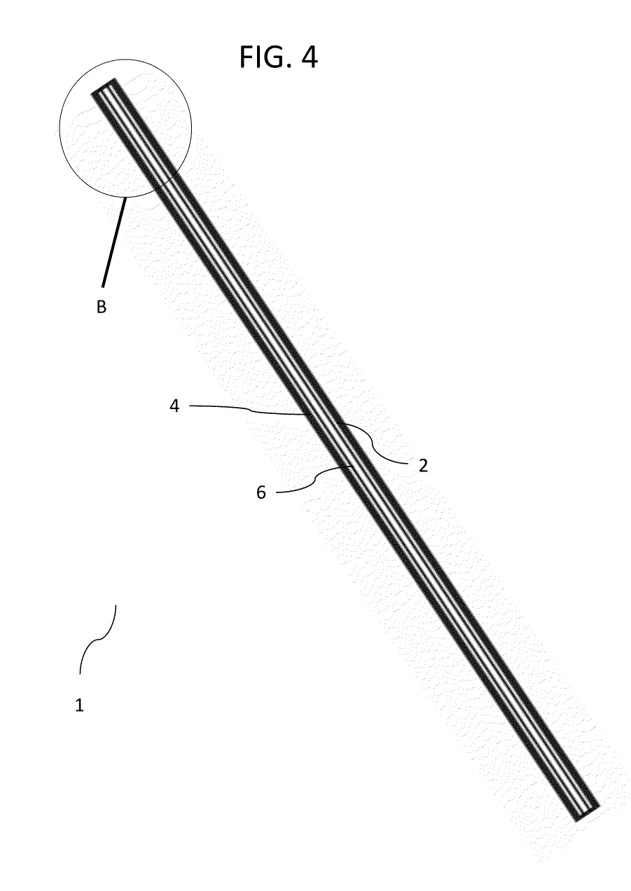

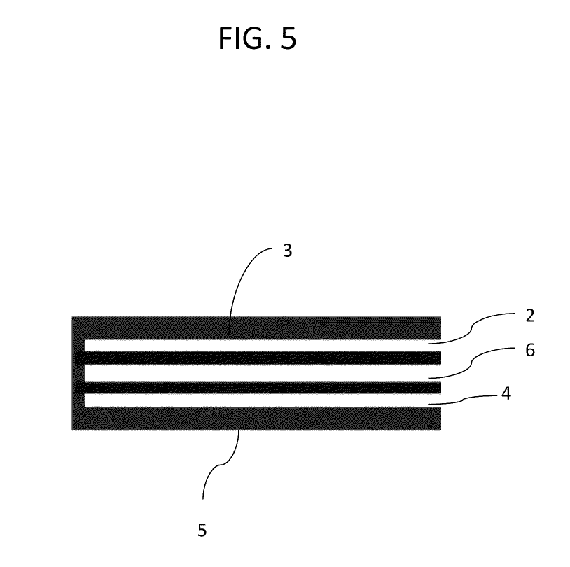

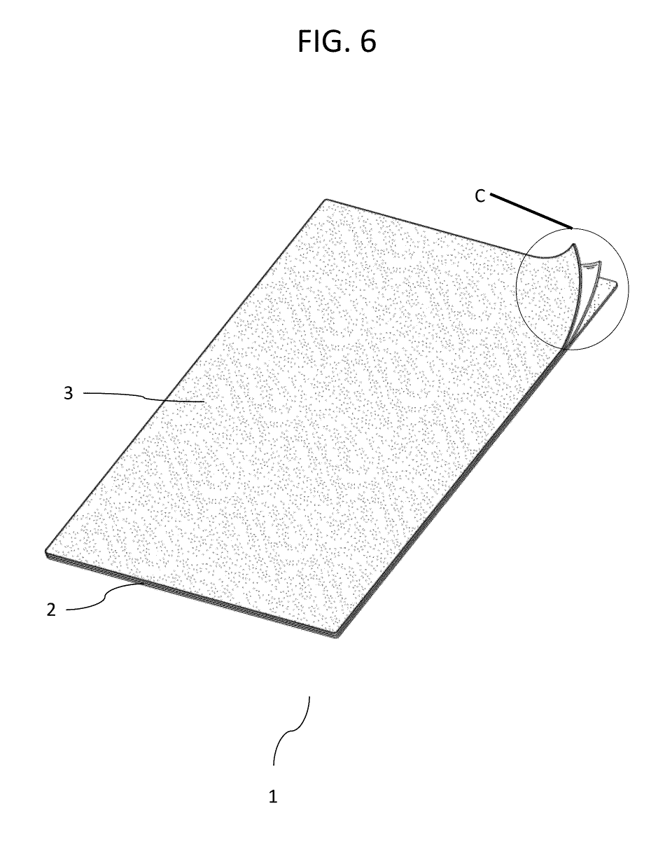

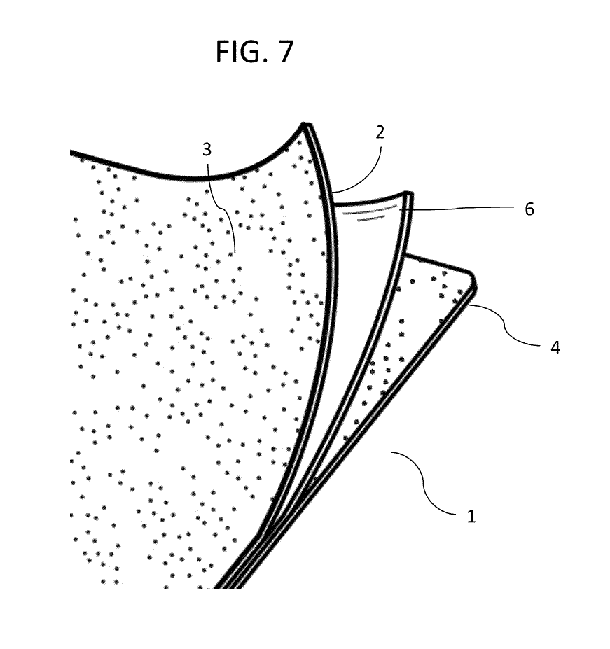

As illustrated in FIGS. 1-7, the present invention is a handheld, disposable, cleaning wipe 1 composed of flexible materials. The wipe may be composed of materials for cleaning human skin, or it may be composed of materials for cleaning glass, countertops, appliances, and other kitchen or bathroom surfaces. The term “disposable” means that the wipe is not intended for reuse (i.e., it is are intended to be discarded after a single use), and that it is flushable on a standard toilet and recyclable.

The wipe 1 contains a substantially planar top layer 2 with a top surface 3 and a bottom surface (not shown). The wipe further contains a substantially planar bottom layer 4 with a bottom surface 5 and a top surface (not shown).

The top 2 and bottom layer 4 are substantially absorbent and pre-moistened with a cleaning solution. The term “absorbent” refer to the ability of the top 2 and bottom layer 4 to retain liquid under a hand-applied force such as compression or squeezing. The top 2 and bottom layer 4 may be pre-moistened or infused with cleaning solutions that may be non-irritating, hypoallergenic, anti-bacterial, anti-viral, anti-fungal, fragranced, fragrance-free, solutions containing alcohol, alcohol-free solutions, or any combination thereof.

The top surface 3 of top layer 2, and the bottom surface 5 of bottom layer 4 are both usable as cleaning surfaces on skin, glass, countertops, or appliances.

The wipe contains an intermediate, substantially planar, non-cleaning, fluid-impervious plastic layer 6. The top surface of the intermediate plastic layer 6 (not shown) is adhered to the bottom surface of top layer 2; and the bottom surface of intermediate plastic layer 6 (not shown) is adhered to the top surface of bottom layer 4. The top 2 and bottom layer 4 are physically adhered to the intermediate plastic layer 6 to allow the wipe 1 to resist any tearing. The intermediate plastic layer 6 is composed of a flexible, water-impervious material. The intermediate plastic layer 6 can be made with biodegradable or flushable plastic so that the product can be flushed in addition to thrown into a trash receptacle.

The intermediate plastic layer 6 prevents any transmission of fluid or solids between the top layer 2 and the bottom layer 4, including the infused cleaning solution. The intermediate plastic layer 6 acts as a barrier for the contaminants, including bacteria, germs, viruses, or small portions of the messes being cleaned between the top layer 2 and the bottom layer 4. The plastic layer 6 physically prevents any material from the top layer 2 moving to the bottom layer 4.

The two separate absorbent surfaces of top surface 3 and bottom surface 5 doubles the absorbing and cleaning power of the wipe 1.

The top layer 2, the bottom layer 4, and the intermediate layer 6 are all substantially identical in shape, width, and length. In variations of the subject invention, the three layers, 2, 4 and 6 may be 1″ to 16″ in width, and 1″ to 16″ in length. The symmetrical shape of the wipe 1 allows doubling of the usable area and for folding and reuse of the same wipe for smaller messes. The top layer 2, intermediate layer 6, and the bottom layer 4 all comprise the substantially same symmetrical shape. This shape may be substantially rectangular, square, circular, hexagonal, or octagonal. The symmetrical shape of the wipe 1 design allows it to be folded into dispensers.

This invention completely solves that problem of contaminants being transmitted onto a user's hand. This wipe 1 is a more sanitary product that reduces the spread of illness. This wipe is also more efficient since it reduces the overall number of wipes used when.

In another variation of the invention, a pocket may be formed at one end of the wipe 1 to allow the user to insert a hand or fingers in between the bottom surface of intermediate layer 6 and either the top surface of the bottom layer 4 or the bottom surface of top layer 2. This insertion would allow the fingers or hand to be fully encased between the intermediate layer 6 and one of the other layers 2 or 4, so that more dexterity can be employed in cleaning with the wipe 1, while the hand remains fully protected from contaminants.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein

What is claimed is:

1. A handheld disposable skin wipe comprising:
a substantially planar first absorbent layer with a top surface and a bottom surface, wherein the first absorbent layer is infused with a first solution;
a substantially planar second absorbent layer with a top surface and a bottom surface, wherein the second absorbent layer is infused with a second solution;
a substantially planar fluid impervious layer with a top surface and a bottom surface, wherein the top surface of the fluid impervious layer is attached to the bottom surface of the first absorbent layer, further wherein the bottom surface of the fluid impervious layer is attached to the top surface of the second absorbent layer;
wherein the fluid impervious layer prevents fluid from being transferred between the first absorbent layer to the second absorbent layer.

2. The skin wipe of claim 1, wherein the first solution and the second solution are selected from the group comprising: a skin non-irritating composition, a hypoallergenic composition, an anti-bacterial composition, an anti-viral composition, an anti-fungal composition, a fragrance, a fragrance-free composition, an aqueous alcoholic composition, an aqueous alcohol-free composition, and any combination thereof.

3. The skin wipe of claim 1, wherein the first absorbent layer, the second absorbent layer, and the fluid impervious layer are each substantially identical to each other in length, width, and shape.

4. The skin wipe of claim 1, wherein the first absorbent layer, the second absorbent layer, and the fluid impervious layer comprise the same symmetrical shape selected from the group consisting of rectangular, square, circular, hexagonal, and octagonal.

5. The skin wipe of claim 1, wherein wipe is substantially biodegradable within 6 months of placement in a landfill.

6. The skin wipe of claim 1, wherein the wipe comprises a thickness less than one-half inch.

7. A handheld, disposable, flexible, cleaning wipe comprising:
a substantially flat first liquid-retaining layer with a top surface and a bottom surface, wherein the first liquid-retaining layer is pre-moistened with an anti-bacterial and anti-viral solution;
a substantially flat second liquid-retaining layer with a top surface and a bottom surface, wherein the second liquid-retaining layer is pre-moistened with the anti-bacterial and anti-viral solution;
a substantially flat water-impervious layer with a top surface and a bottom surface, wherein the top surface of the fluid impervious layer is attached to the bottom surface of the first liquid-retaining layer, further wherein the bottom surface of the fluid impervious layer is attached to the top surface of the second liquid-retaining layer;
wherein the water-impervious layer prevents any fluid from being transmitted between the first liquid-retaining layer and the second liquid-retaining layer.

8. The cleaning wipe of claim 7, wherein the first liquid-retaining layer, the second liquid-retaining layer, and the water-impervious layer are each substantially identical to each other in length, width, and shape.

9. The cleaning wipe of claim 7, wherein the first liquid-retaining layer, the second liquid-retaining layer, and the water-impervious layer comprise the same symmetrical shape selected from the group consisting of rectangular, square, circular, hexagonal, and octagonal.

10. The cleaning wipe of claim 7, wherein wipe is substantially biodegradable within 6 months of placement in a landfill.

11. The cleaning wipe of claim 7, wherein the wipe comprises a thickness less than one-half inch.

12. A handheld, disposable, flexible, cleaning wipe comprising:
a substantially flat first liquid-retaining layer with a top cleaning surface and a bottom surface, wherein the first liquid-retaining layer is pre-moistened with an anti-bacterial, anti-viral, and anti-fungal solution;
a substantially flat second liquid-retaining layer with a top surface and a bottom cleaning surface, wherein the second liquid-retaining layer is pre-moistened with the anti-bacterial, anti-viral solution, and anti-fungal solution;
a substantially flat water-impervious layer with a top surface and a bottom surface, wherein the top surface of the water-impervious layer is attached to the bottom surface of the first liquid-retaining layer, further wherein the bottom surface of the water-impervious layer is attached to the top surface of the second liquid-retaining layer;
wherein the water-impervious layer prevents any fluid from being transmitted between the first liquid-retaining layer and the second liquid-retaining layer.

13. The cleaning wipe of claim 12, wherein the top cleaning surface of the first layer and the bottom cleaning surface of the bottom layer are both configured to clean surfaces selected from the group consisting of: skin, glass, countertops, stovetops, appliances, and any combination thereof.

14. The cleaning wipe of claim 12, wherein the first liquid-retaining layer, the second liquid-retaining layer, and the water-impervious layer are each substantially identical to each other in length, width, and shape.

15. The cleaning wipe of claim 12, wherein the first liquid-retaining layer, the second liquid-retaining layer, and the water-impervious layer comprises the same symmetrical shape selected from the group consisting of rectangular, square, circular, hexagonal, and octagonal.

16. The cleaning wipe of claim 12, wherein wipe is substantially biodegradable within 6 months of placement in a landfill.

17. The cleaning wipe of claim 12, wherein the wipe comprises a thickness less than one-half inch.
